(19) United States
(12) Patent Application Publication
(10) Pub. No.: US 2018/0144853 A1
(43) Pub. Date: May 24, 2018

(54) Cup-Magnet Module of Composite Structure

(71) Applicant: KANG YAO, DELRAY BEACH, FL (US)

(72) Inventor: KANG YAO, DELRAY BEACH, FL (US)

(73) Assignee: AMERICAN MAGNETIC ENGINEERING, INC., DELRAY BEACH, FL (US)

(21) Appl. No.: 15/359,434

(22) Filed: Nov. 22, 2016

(51) Int. Cl. H01F 7/02

(52) U.S. Cl. CPC H01F 7/021; H01F 7/0221

(57) ABSTRACT

The present invention relates to a novel cup-magnet composite structure by using the cup-magnets to generate both vertical lift and horizontal shift. This module functions uniquely due to its coherent magnetic force and the innovative design. According to this invention, the cup-magnet module can be embedded into many products of various applications. The module can be made at efficient cost to perform great function such as providing cushion support with gentle magnetic therapy in applications of magnetic pillow, chair and mattress, etc. . . . It can also be embedded in the shoe to provide the luxury comfort of relieving the foot-ache via magnetic cushion. In many applications, it also reduces the energy use and its associated impact on the environment by replacing the traditional component that runs on electricity otherwise.

### BACKGROUND OF THE INVENTION

Magnets are playing a more and more important role in everyday life. Many times magnets are integrated with other parts to serve as a module. To achieve this it requires comprehensive approach including composite structure, 3D printing and plastic molding etc. . . . A cup-magnet module is designed as a form of cup-magnet based composite structure which is composed of cup magnets, linkage system and or internal cushion etc. . . . It is made with useful movement and durable strength at relatively low cost. This cup-magnet module can be widely used in products with cushion support, such as shoe, pillow, chair and mattress etc. . . . U.S. Pat. No. 7,859,157 B2 discloses a magnetic levitation system for supporting an object against gravity by a supporting force includes a magnet aligned in a vertical position and coupled to the object, a supporting-field generator and a stabilization system. U.S. Pat. No. 6,626,820 B1 discloses a magnetic mattress pad comprising an uppermost portion, an upper portion, a lower portion and alternating magnetic means for providing changes in magnetic polarity. U.S. Pat. No. 7,694,440 B1 discloses a structure of an insole, and more particularly to an insole that is implemented with strong elasticity and retention properties, which is inserted into an article of footwear to provide the user with cushioning and comfort. The prior inventions are good in their own features yet impractical to promote in daily life due to its complicated structure and unfavorable cost. To solve this problem, the present invention is designed to provide a cup-magnet composite structure which has great magnetic moving feature thanks to its unique structure. It can provide special feature of magnetic swing in certain direction which can be controlled via the magnetic field distribution in the module. Also this module is easy to make and promote due to its simplicity and low cost. It can be embedded into a wide variety of products with different application.

For the application of magnetic pillow, the cup-magnet module is embedded inside the pillow case and integrated with pillow base to provide the extra support and magnetic therapy on the neck. For the application of mattress cushioning, the heavy-duty cup-magnet module can provide vertical spring-like support and more importantly the gentle horizontal swing. All these good features are achieved through the built-in magnetic field distribution and the unique balance-and-check function of the cup-magnet module.

### SUMMARY OF THE INVENTION

The cup-magnet module comprises:

(1) a pair of cup-magnets to form the basis of cup-magnet module, a pair of cup-magnets can be any shape and size.

(2) a pair of cup-magnets holders made by 3D printing, plastic molding or hi-precision machining etc.;

(3) sturdy fine string to link the pair of cup-magnet via the cup holders.

(4) linkage for the pair of cup-magnets.

(a) flexible linkage

use flexible string to link up the pair of the cup-magnet with option of using elastic material as cushion in between. The flexible string can be of material such as nylon line of fine alloy wire etc. . . . The elastic material for the cushion can be rubber, sponge, hi-polymer material etc. . . .

(b) rigid linkage

rod-ball-pin structure in connecting the pair of the cup-magnets. Rod-ball-pin material includes metal, hi-strength plastic and carbon fiber etc.

In the cup-magnet module, a pair of cup-magnet is assembled with cup-magnet holder to form the core of the module. The pair of cup-magnets can be any in shape and size for application. Here, for the purpose of simple illustration, we use the module of round disc cup-magnet. Yet this module structure also applies to other shape of cup-magnet as well, such as square, rectangular or even polygon etc. . . . The iron/steel cup over the magnet improves the magnetic efficiency by reflecting the magnetism from one side onto the other side, which can reduce the bulk size of the magnets required for this type of application. Small holes are drilled on the edge of each cup-magnet holder. A flexible string links and guides the movement of the pair of cup-magnets. It controls the movement by uniformly winding the string to link the pair of the cup-magnets, i.e., the horizontal swing is easily controlled by adjusting the length of the link string. A special layer of elastic material acts as a cushion to provide extra support between the cup-magnet module, which softens the impact between the magnets and adds the comfort of the composite structure in many applications. Thus, the cup-magnet module can generate vertical reciprocation and horizontal swing, which is desired in many applications.

In FIG. 2, the magnetic fields of magnet alone and magnet with iron/steel cup are measured separately. The surface of the magnet with iron/steel cup is north pole and the surrounding edge is south pole, which occurs since the iron/steel cup reflects the magnetism of the non-working surface of the magnet. In FIG. 3, a pair of magnets of cup-magnet module is fully aligned. The working area of each magnet is north pole and cup edge surface is south pole. The pair of magnets repels each other. The balance is delicate as the margin for horizontal swing is restricted by the string linkage. Once the cup-magnet module moves off its full alignment position, the pair of magnet starts to move along the opposite direction in the horizontal plane. Since the horizontal movement of magnets is almost frictionless, the pair of magnets can move a short distance in the horizontal direction until it reaches the limit of the link string. This kind of movement occurs due to the interaction force F between cup edge and working surface. The vector force F is projected into the horizontal vector force Fx and vertical vector force Fy, which makes the magnets travel in each direction accordingly.

In FIG. 4a, the top cup-magnet of the module travels a small distance away in the horizontal direction given an external source of input initiates the movement. In the mean while, the pull forces between the cup-magnets are created. The pair of magnet pulls each other causing the cup-magnets to move in both directions, i.e., vertical and horizontal. In FIG. 4b and FIG. 4c, the top cup-magnet moves further away horizontally until the retraction force from the spring is larger than the push force by the cup-magnets. Also shown in FIG. 4c, the spring pulls back the magnets along the opposite direction horizontally until the pair of magnets reaches the fully-aligned position again. When the external force is applied in the cup-magnet module, the top cup-magnet moves along accordingly. For example, in the application of magnetic seat cushion, the external force is formed by the gentle movement of people sitting on it when he stretches the limb or relaxes the body. As for the mattress, the external force is formed when people lying on the mattress rolls over from one side to the other side or some other gentle movement. This in turn generated the external force on the cup-magnet and the mattress swings gently in response.

In summary, the cup-magnet module is partially aligned due to the horizontal movement of the top cup-magnet. The horizontal movement of the cup-magnet is further defined by the link string or spring connection in the module. As illustrated in FIG. 6, FIG. 7 and FIG. 8 there are three ways in controlling the top cup-magnet's movement. FIG. 6 illustrates the basic way of connection, where the link string is used to control the cup-magnet's movement. Also shown in FIG. 6, the internal cushion prevents the cup-magnets from sticking together besides absorbing the impact between the cup-magnets. FIG. 7 shows another way of connection, i.e., the rigid rod-ball-pin in the center links the pair of cup-magnets. It guides the magnet's movement accordingly. In FIG. 8, two springs add to the control of the magnet's movement on the basis of the original string connection which is illustrated in FIG. 7.

As shown in FIG. 9, the cup-magnet module is embedded inside the bottom chamber of the shoe and acts as comfortable magnetic cushion for the foot. It can also be embedded in/around the insole section to relieve the foot ache. Our heavy-duty cup-magnet module (i.e., the module with rigid rod-ball-pin connection) in FIG. 7 can find application in many conditions, such as luxury aerospace seat cushion, where its powerful magnetic function can aid in the flexible movement control within limited space without extra power input. The magnetic field distribution and hence the movement of cup-magnets can be adjusted by the dimension of the inserted spacer-1 in the cup-magnet module. The larger the spacer, the more horizontal distance the cup-magnet can move. This cup-magnet structure with high strength rigid rod connection also can provide more support in the vertical direction since its cup-magnets are larger and hence more repelling force.

### REFERENCE

1. U.S. Pat. No. 7,859,157 B2, Dec. 1, 2006-Dec. 28, 2010. Heinrich Baur, Magnetic levitation system.

2. U.S. Pat. No. 6,626,820 B1, Apr. 29, 2002-Sep. 30, 2003. Vincent Ardizzone, magnetic mattress pad.

3. U.S. Pat. No. 7,694,440 B1, Dec. 31, 2006-Apr. 13, 2010. Albert Wu, Insole cushioning device with repelling magnetic field.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in each drawing. In the drawings:

FIG. 1 shows a perspective view of structure of cup-magnet magnet.

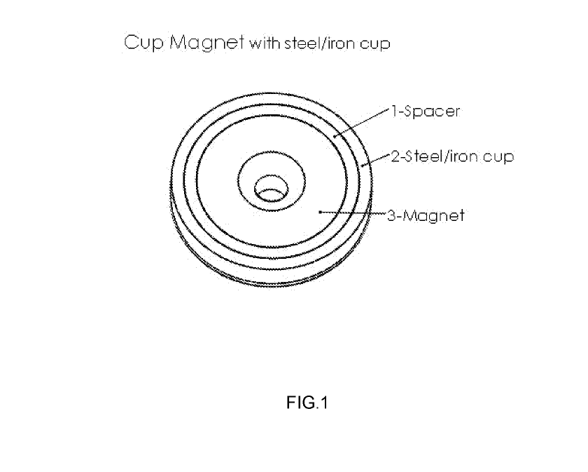

FIG. 2 shows a comparative view of magnetic field distribution of a magnet and a cup-magnet.

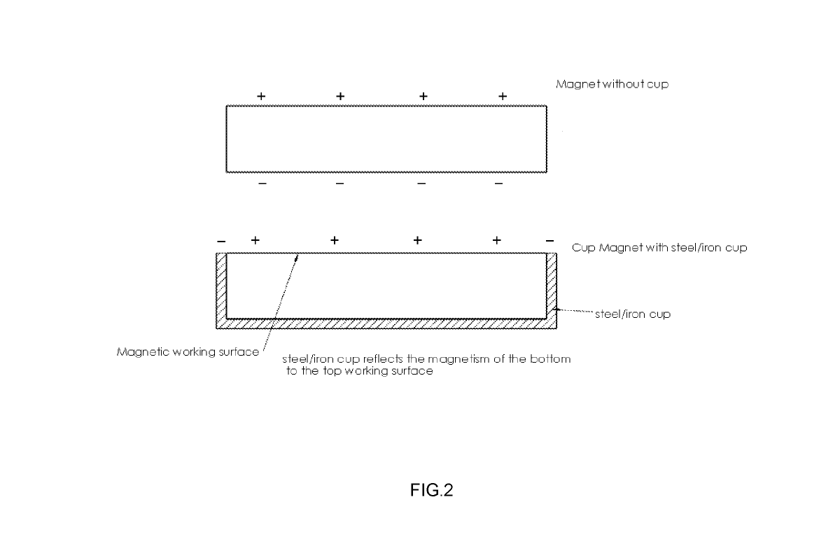

FIG. 3 shows a perspective view of force distribution with regard to its magnetic polarity in a pair of fully-aligned cup-magnets.

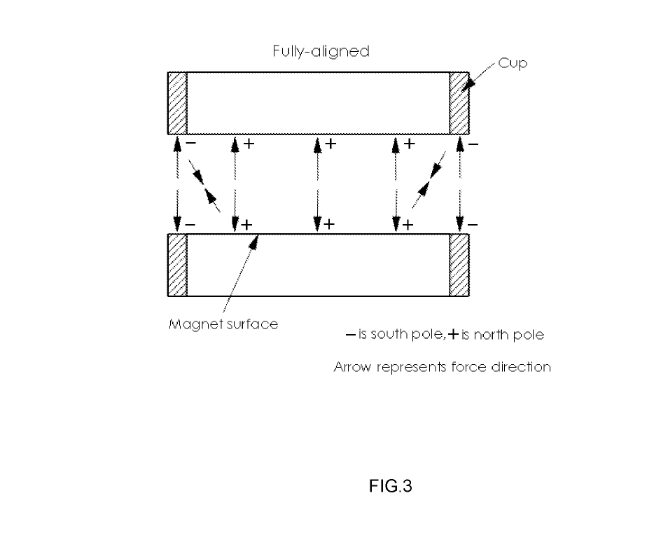

FIG. 4a shows a perspective view of the initial stage of horizontal movement and force distribution in a pair of partially-aligned cup-magnets.

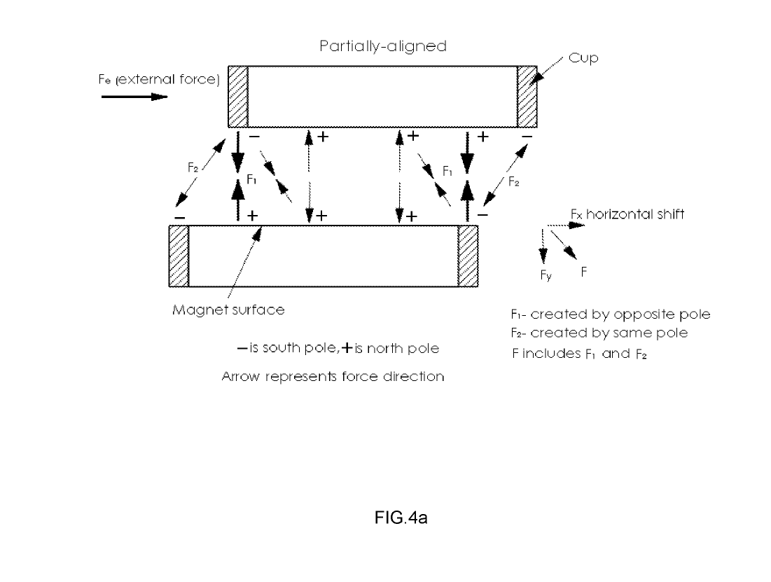

FIG. 4b shows a perspective view of developing stage of horizontal movement and force distribution in a pair of partially-aligned cup-magnets.

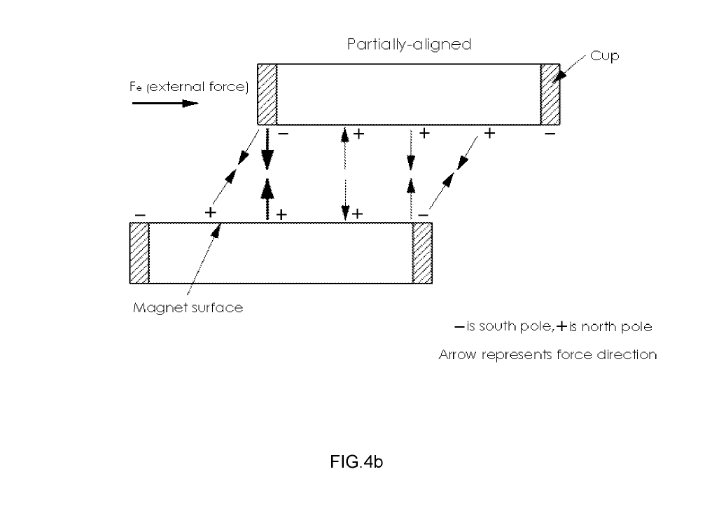

FIG. 4c shows a perspective view of developed stage of horizontal movement and force distribution in a pair of partially-aligned cup-magnets. A retaining spring is triggered to retract both cup-magnets in regaining balance.

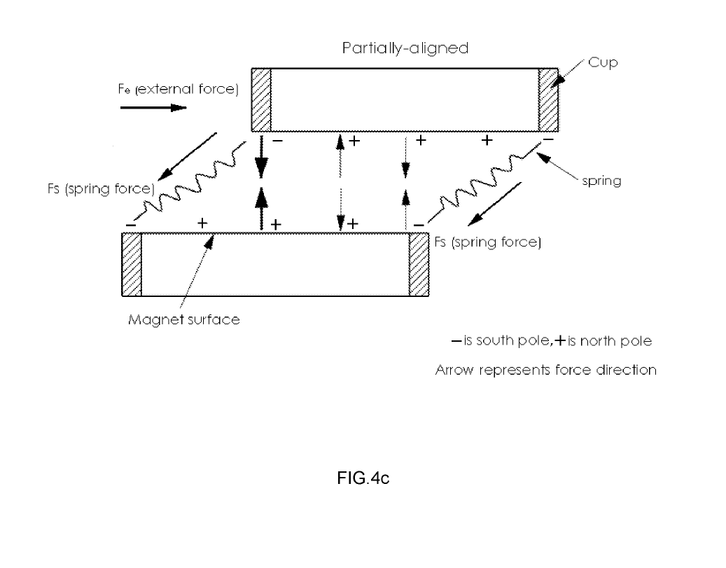

FIG. 5 shows a cup-magnet with holder.

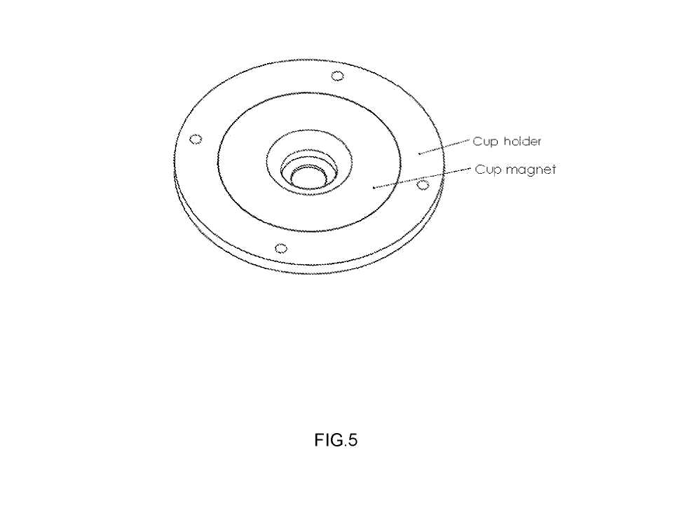

FIG. 6 shows a perspective view of a cup-magnet module with string connection.

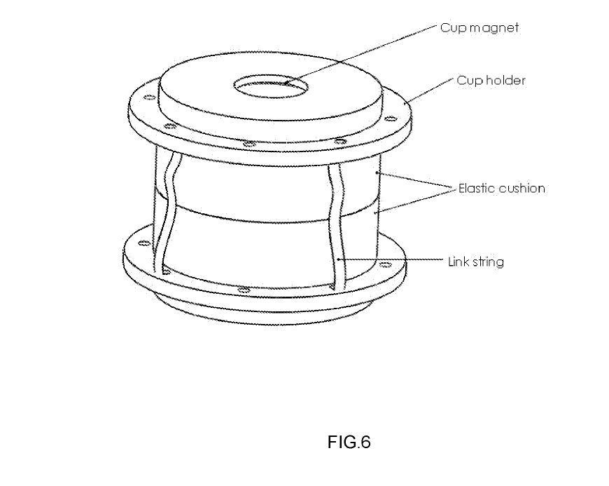

FIG. 7 shows a perspective view of cup-magnet composite structure with rod-ball-pin connection.

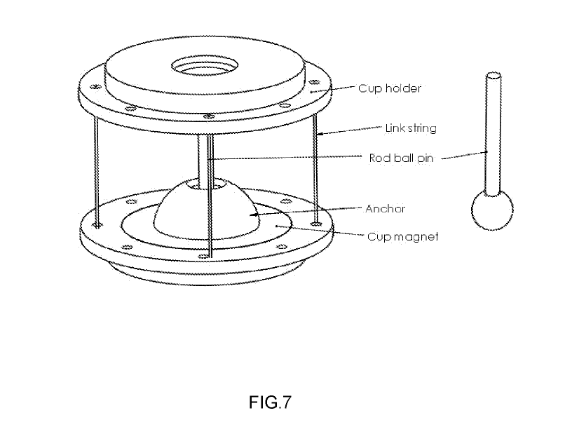

FIG. 8 shows a perspective view of heavy-duty cup-magnet module with spring/string regulation.

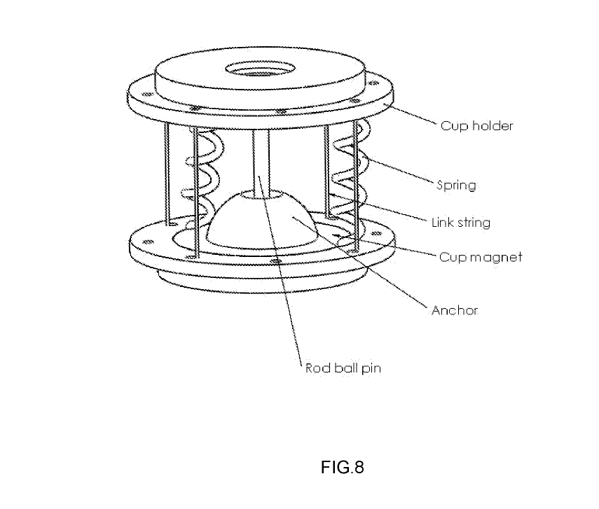

FIG. 9 shows a perspective view of cup-magnet modules embedded inside a shoe.

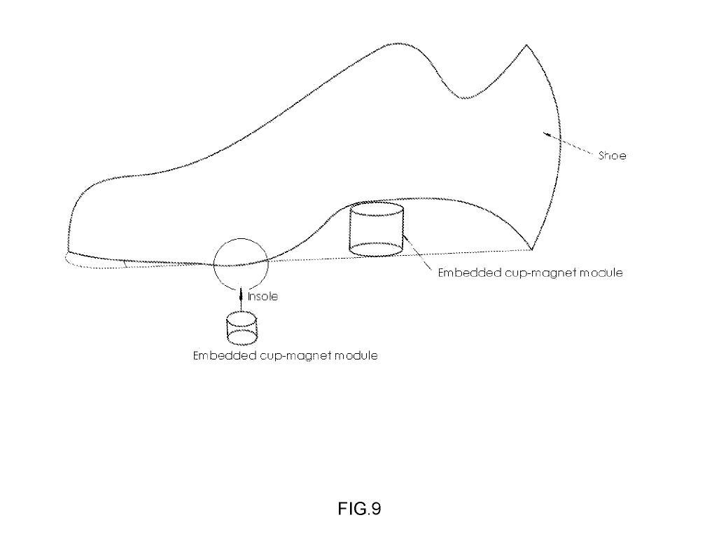

1-7. (canceled)

8. A pair of cup magnets with rod-ball-pin connection composed of cup magnets with mounting hole.

9. Rod-ball-pin is assembled around the center of the cup magnets.

10. The pin is positioned inside the hole of the cup-magnet.

11. Rod-ball-pin connection is to guide the movement of the pair of cup magnets.
